(19) United States
(12) Patent Application Publication
(10) Pub. No.: US 2007/0269781 A1
(43) Pub. Date: Nov. 22, 2007

(54) EDWOOD / Educational hollywood

(76) Inventor: Brian Lamont aka Bras Taylor aka Dobane, Newark, NJ (US)

Correspondence Address: Brian Lamont Taylor a.k.a. Bras Dobane, 120 Vassar Avenue, Newark, NJ, 07112, US

(21) Appl. No.: 11/403,130

(22) Filed: May 22, 2006

(51) Int. Cl. G09B 19/00

(52) U.S. Cl. 434/219

(57) ABSTRACT

EDWOOD allows the average college student the opportunity to experience Show-Business on “their terms,”-which will be as prestigious as it will be educational. EDWOOD umbrellas two national organizations which students and community artists can join. EDWOOD allows students to be movie stars and make the dean's list at the same time while still building for themselves an additional option at the time of graduation. EDWOOD encourages students to become entrepreneurs in areas ranging from pop corn to security for talent. EDWOOD will be synonymous with Hollywood as NCAA football is synonymous with the NFL.

Every Prime time arena has its college counterpart. The NFL has NCAA College Football, The NBA has not only NCAA College Basketball, but also the WNBA as well . . . and now Hollywood will have its EDWOOD!

EDWOOD is a brand new film industry vehicle for college students and community artists which is composed of an entity, Square Deal Media Communications, LLC. and an organization, the United Collegiate Artists Unlimited.

These bodies are designed to create employment for college students (both during and after graduation and in all areas of filmmaking which particularly include acting, make-up artists, gaffers, Dolly pushers, Best boys, storyboard artists, wranglers, animal trainers, still photographers, motion photographers, drafters, CGI renderers, editors, producers, managers, musical composors for soundtracks, singers for soundtracks, stunt actors, screenwriters, pop corn vendors, the designers and creators of newsletters and on-line news shows, the designers and of costumes, and set builders and construction workers). Additionally both bodies plan to create the same jobs for professional filmmakers and sub-collegiate students in communities throughout the United States and world.

First students and community filmmakers shall join the United Collegiate Artists Unlimited( which eventually plans to have a chapter on each campus in the united states with still others located in small towns and in cities around the country). Now, a large portion of the UCAU will be made up of unknown and independent owners of film companies. These owners hire cast and crew members from pools of college students in the surrounding areas before filming( or in some case in other areas).

Film projects will include all genres of film which will particularly include comedies, dramas, horror films, film noir pieces, documentaries, westerns, biographical and historical epics, etc.

Once the films are made they are then sent to Square Deal Media Communications for review. A decision is made and four to five films are slated for wide release to all of the UCAU campuses (in some cases popularly selected films are provided with red carpet screenings). The films will receive wide release until unpopular where they will be pulled and replaced with another film. Films will be screened in a select lecture hall or auditorium and viewed on a large screen. UCAU members serve as the movie theater staff as well.

Advertisements for both SDMC and the UCAU will appear on bulletin boards, electronic rotation screens on digital television screens all around the campus(along with other advertisements) and in every dorm and student center, including the mini campus theater itself.

Additionally, during Premiere Days colleges will host the cast and filmmakers to ceremonial practices, luncheons, Q&A periods, opportunity to teach workshops, etc. Student UCAU members are encouraged to become entrepreneurs in fields such as concessions, wardrobe, junior agent representation(for law students), accounting(for accounting majors), etc.

Students are then encouraged to seek full time employment with a company or start their company after graduation.

Students may start a business in any area they desire but are strongly encouraged to open film companies or news magazines, both on-line and hard copy.

Proceeds shall be subtracted from each ticket sold and used for national scholarships and donations back to each school.

Through EDWOOD SDMC and the UCAU will participate in numerous community based initiatives.

Lastly, EDWOOD will institute an annual awards show similar to the Academy Awards.

### SUMMARY

The following pages deal with a new industry called EDWOOD. EDWOOD is the Hollywood of Colleges and Universities and includes union-like organizations for both student artists in colleges and community motion picture artists from cities and towns throughout the world.

The two main conduits to EDWOOD's success and uniqueness are Square Deal Media Communications (SDMC), which handles film distribution to colleges and universities throughout the world and the United Collegiate Artists Unlimited (UCAU) which serves as a union-like organization representing artists from colleges to artists in inner-cities and suburbs everywhere. In essence any artist not represented by a major union will join the UCAU.

What I claim as my invention is:

1. These bodies are designed to create employment for college students (both during and after graduation and in all areas of filmmaking which particularly include acting, make-up artists, gaffers, Dolly pushers, Best boys, storyboard artists, wranglers, animal trainers, still photographers, motion photographers, drafters, CGI renderers, editors, producers, managers, musical composors for soundtracks, singers for soundtracks, stunt actors, screenwriters, pop corn vendors, the designers and creators of newsletters and on-line news shows, the designers and of costumes, and set builders and construction workers). Additionally both bodies plan to create the same jobs for professional filmmakers and sub-collegiate students in communities throughout the United States and world.
First students and community filmmakers shall join the United Collegiate Artists Unlimited( which eventually plans to have a chapter on each campus in the united states with still others located in small towns and in cities around the country). Now, a large portion of the UCAU will be made up of unknown and independent owners of film companies. These owners hire cast and crew members from pools of college students in the surrounding areas before filming( or in some case in other areas).
Film projects will include all genres of film which will particularly include comedies, dramas, horror films, film noir pieces, documentaries, westerns, biographical and historical epics, etc.
Once the films are made they are then sent to Square Deal Media Communications for review. A decision is made and four to five films are slated for wide release to all of the UCAU campuses (in some cases popularly selected films are provided with red carpet screenings). The films will receive wide release until unpopular where they will be pulled and replaced with another film. Films will be screened in a select lecture hall or auditorium and viewed on a large screen. UCAU members serve as the movie theater staff as well.
Advertisements for both SDMC and the UCAU will appear on bulletin boards, electronic rotation screens on digital television screens all around the campus(along with other advertisements) and in every dorm and student center, including the mini campus theater itself.
Additionally, during Premiere Days colleges will host the cast and filmmakers to ceremonial practices, luncheons, Q&A periods, opportunity to teach workshops, etc. Student UCAU members are encouraged to become entrepreneurs in fields such as concessions, wardrobe, junior agent representation(for law students), accounting(for accounting majors), etc.
Students are then encouraged to seek full time employment with a company or start their company after graduation.
Students may start a business in any area they desire but are strongly encouraged to open film companies or news magazines, both on-line and hard copy.
Proceeds shall be subtracted from each ticket sold and used for national scholarships and donations back to each school.
Through EDWOOD SDMC and the UCAU will participate in numerous community based initiatives.
Lastly, EDWOOD will institute an annual awards show similar to the Academy Awards.
Every Prime time arena has its college counterpart. The NFL has NCAA College Football, The NBA has not only NCAA College Basketball, but also the WNBA as well . . . and now Hollywood will have its EDWOOD!
